(19) United States
(12) Patent Application Publication
(10) Pub. No.: US 2026/0035217 A1
(43) Pub. Date: Feb. 5, 2026

(54) MULTI-PULLEY TELESCOPIC MECHANISM AND CRANE

(71) Applicant: XUZHOU HEAVY MACHINERY CO., LTD., Jiangsu (CN)

(72) Inventors: Shanhua MA, Jiangsu (CN); Suxun CHEN, Jiangsu (CN); Wei ZHU, Jiangsu (CN); Yanwei ZHANG, Jiangsu (CN)

(73) Assignee: XUZHOU HEAVY MACHINERY CO., LTD., Jiangsu (CN)

(21) Appl. No.: 18/995,149

(22) PCT Filed: Dec. 22, 2022
(86) PCT No.: PCT/CN2022/140904

§ 371 Date: Jan. 16, 2025

(30) Foreign Application Priority Data
Jul. 29, 2022 (CN) 202210912303.5

(51) Int. Cl. B66C 23/70

(52) U.S. Cl. CPC B66C 23/703; B66C 23/705

(57) ABSTRACT

The invention discloses a multi-pulley telescopic mechanism, and belongs to the technical field of cranes. The multi-pulley telescopic mechanism comprises a telescopic mechanism, a first boom-extension rope, a second boom-extension rope, a third boom-extension rope, a basic boom, and a second boom, a third boom, a fourth boom and a fifth boom which are sequentially inlaid in the basic boom. The invention further discloses a crane, comprising the multi-pulley telescopic mechanism.

### TECHNICAL FIELD

The invention relates to a multi-pulley telescopic mechanism and a crane, and belongs to the technical field of cranes.

### TECHNICAL BACKGROUND

At present, a majority of mainstream five-boom cranes on the market adopts a double-cylinder rope type telescopic mechanism, wherein a first telescopic cylinder controls a second boom to extend and retract separately, a second telescopic cylinder controls a third boom, a fourth boom and a fifth boom to extend and retract, the telescoping efficiency is low, the weight of the two telescopic cylinders is large, the cost is high, and particularly, the hoisting capacity of a long boom of a crane in long-term operation is affected. Some five-boom cranes adopt a single-cylinder rope type telescopic mechanism. However, during hoisting, the force borne by a fourth boom-extension rope is twice that borne by a fifth boom-extension rope, and the force borne by a third boom-extension rope is twice that borne by the fourth boom-extension rope, that is, the force borne by the ropes is doubled, so the hoisting capacity of the cranes is severely limited.

### SUMMARY OF THE INVENTION

In view of the defects in the prior art, the invention provides a multi-pulley telescopic mechanism and a crane to solve the technical problems that five-boom cranes in the prior art are high in cost and low in telescoping efficiency and the hoisting capacity of the cranes is severely limited.

To solve the above technical problems, the invention adopts the following technical solutions:
in a first aspect, the invention provides a multi-pulley telescopic mechanism, comprising a telescopic mechanism, a first boom-extension rope, a second boom-extension rope, a third boom-extension rope, a basic boom, and a second boom, a third boom, a fourth boom and a fifth boom which are sequentially inlaid in the basic boom, wherein:
a movable tail end of the telescopic mechanism is connected to the basic boom, a stationary tail end of the telescopic mechanism is connected to the second boom, a first boom-extension steering mechanism is mounted at a stationary front end of the telescopic mechanism, one end of the first boom-extension rope is fixedly connected to the third boom, the other end of the first boom-extension rope is wound around the first boom-extension steering mechanism and then fixedly connected to the basic boom, a first boom-extension steering assembly is mounted between the third boom and the fourth boom, one end of the second boom-extension rope is fixedly connected to the basic boom, the other end of the second boom-extension rope is wound around the first boom-extension steering assembly and then fixedly connected to the third boom, a second boom-extension steering assembly is mounted between the fourth boom and the fifth boom, one end of the third boom-extension rope is fixedly connected to the fifth boom, and the other end of the third boom-extension rope is wound around the second boom-extension steering assembly and then fixedly connected to the basic boom.

Furthermore, the movable tail end of the telescopic mechanism is connected to a boom tail of the basic boom, the stationary tail end of the telescopic mechanism is connected to a boom tail of the second boom, one end of the first boom-extension rope is fixedly connected to a boom tail of the third boom, the other end of the first boom-extension rope is wound around the first boom-extension steering mechanism and then fixedly connected to the boom tail of the basic boom, the first boom-extension steering assembly is mounted between a boom head of the third boom and a boom tail of the fourth boom, one end of the second boom-extension rope is fixedly connected to the boom tail of the basic boom, the other end of the second boom-extension rope is wound around the first boom-extension steering assembly and then fixedly connected to the boom head of the third boom, the second boom-extension steering assembly is mounted between a boom head of the fourth boom and a boom tail of the fifth boom, one end of the third boom-extension rope is fixedly connected to the boom tail of the fifth boom, and the other end of the third boom-extension rope is wound around the second boom-extension steering assembly and then fixedly connected to the boom tail of the basic boom.

Furthermore, the first boom-extension steering assembly comprises a second boom-extension steering mechanism and a third boom-extension steering mechanism, the second boom-extension steering mechanism is mounted on the third boom, the third boom-extension steering mechanism is mounted on the fourth boom, and the other end of the second boom-extension rope is sequentially wound around the second boom-extension steering mechanism and the third boom-extension steering mechanism and then fixedly connected to the third boom.

Furthermore, the second boom-extension steering mechanism is mounted at the boom head of the third boom, the third boom-extension steering mechanism is mounted at the boom tail of the fourth boom, and the other end of the second boom-extension rope is sequentially wound around the second boom-extension steering mechanism and the third boom-extension steering mechanism and then fixedly connected to the boom head of the third boom.

Furthermore, the second boom-extension steering assembly comprises a fourth boom-extension steering mechanism, a fifth boom-extension steering mechanism and a sixth boom-extension steering mechanism, the fourth boom-extension steering mechanism and the sixth boom-extension steering mechanism are mounted on the fourth boom, the fifth boom-extension steering mechanism is mounted on the fifth boom, and the other end of the third boom-extension rope is sequentially wound around the fourth boom-extension steering mechanism, the fifth boom-extension steering mechanism and the sixth boom-extension steering mechanism and then fixedly connected to the basic boom.

Furthermore, the fourth boom-extension steering mechanism and the sixth boom-extension steering mechanism are mounted at the boom head of the fourth boom, the fifth boom-extension steering mechanism is mounted at the boom tail of the fifth boom, and the other end of the third boom-extension rope is sequentially wound around the fourth boom-extension steering mechanism, the fifth boom-extension steering mechanism and the sixth boom-extension steering mechanism and then fixedly connected to the boom tail of the basic boom.

Furthermore, the sixth boom-extension steering mechanism is located on an outer side of the third boom-extension rope wound around the fourth boom-extension steering mechanism and the fifth boom-extension steering mechanism.

Furthermore, the sixth boom-extension steering mechanism is located on an inner side of the third boom-extension rope wound around the fourth boom-extension steering mechanism and the fifth boom-extension steering mechanism.

Furthermore, a spatial size of the fourth boom-extension steering mechanism is greater than a spatial size of the sixth boom-extension steering mechanism.

Furthermore, the multi-pulley telescopic mechanism further comprises a first boom-retraction rope, a second boom-retraction rope and a third boom-retraction rope, wherein a first boom-retraction steering mechanism is mounted at the boom tail of the second boom, one end of the first boom-retraction rope is fixedly connected to a boom head of the basic boom, the other end of the first boom-retraction rope is wound around the first boom-retraction steering mechanism and then fixedly connected to the boom tail of the third boom, a second boom-retraction steering mechanism is mounted at the boom tail of the third boom, one end of the second boom-retraction rope is fixedly connected to the stationary front end of the telescopic mechanism or a boom head of the second boom, the other end of the second boom-retraction rope is wound around the second boom-retraction steering mechanism and then fixedly connected to the boom tail of the fourth boom, a third boom-retraction steering mechanism is mounted at the boom tail of the fourth boom, one end of the third boom-retraction rope is fixedly connected to the boom head of the third boom. and the other end of the third boom-retraction rope is wound around the third boom-retraction steering mechanism and then fixedly connected to the boom tail of the fifth boom.

Furthermore, the multi-pulley telescopic mechanism further comprises a fourth boom-retraction rope and a fifth boom-retraction rope, wherein a fourth boom-retraction steering mechanism is mounted at the boom tail of the second boom, one end of the fourth boom-retraction rope is fixedly connected to a boom head of the basic boom, the other end of the fourth boom-retraction rope is wound around the fourth boom-retraction steering mechanism and then fixedly connected to the boom tail of the third boom, a fifth boom-retraction steering mechanism is mounted at the stationary front end of the telescopic mechanism, a sixth boom-retraction steering mechanism is mounted at the boom tail of the third boom, one end of the fifth boom-retraction rope is fixedly connected to the boom tail of the third boom, and the other end of the fifth boom-retraction rope is sequentially wound around the fifth boom-retraction steering mechanism and the sixth boom-retraction steering mechanism and then fixedly connected to the boom tail of the fifth boom.

Furthermore, the first boom-extension steering mechanism, the second boom-extension steering mechanism, the third boom-extension steering mechanism, the fourth boom-extension steering mechanism, the fifth boom-extension steering mechanism and the sixth boom-extension steering mechanism are all pulleys.

Furthermore, the first boom-retraction steering mechanism, the second boom-retraction steering mechanism and the third boom-retraction steering mechanism are all pulleys.

Furthermore, the fourth boom-retraction steering mechanism, the fifth boom-retraction steering mechanism and the sixth boom-retraction steering mechanism are all pulleys.

Furthermore, a hinge base is mounted at a boom tail of the basic boom, the movable tail end of the telescopic mechanism is hinged to the hinge base by means of a hinge pin, a stationary base is mounted at a boom tail of the second boom, and the stationary tail end of the telescopic mechanism is hinged to the stationary base by means of a hinge pin.

Furthermore, the telescopic mechanism is a telescopic cylinder, a tail end of a piston of the telescopic cylinder is the movable tail end of the telescopic mechanism, a tail end of a cylinder barrel of the telescopic cylinder is the stationary tail end of the telescopic mechanism, and a front end of the cylinder barrel of the telescopic cylinder is the stationary front end of the telescopic mechanism.

In another aspect. the invention further provides a crane, comprising the multi-pulley telescopic mechanism.

Compared with the prior art, the invention fulfills the following beneficial effects:
Synchronous extension and retraction of the first boom, the second boom, the third boom, the fourth boom and the fifth boom are realized by means of a single telescopic mechanism, such that the overall weight and cost of the multi-pulley telescopic mechanism can be effectively reduced,
and the hoisting capacity of a crane can be improved to some extent;
the first boom-extension rope, the second boom-extension rope, the third boom-extension rope, the first boom-retraction rope and the fourth boom-retraction rope are fixedly connected to the basic boom, such that telescoping mechanism of the multi-pulley telescopic mechanism is effectively improved;
by means of the first boom-extension steering assembly, the second boom-extension rope wound around the first boom-extension steering mechanism, the second boom-extension steering assembly and the third boom-extension rope wound around the second boom-extension steering assembly, the force borne by the second boom-extension rope and the force borne by the third boom-extension rope can be effectively reduced, thus effectively improving the hoisting capacity of a crane.

### DESCRIPTION OF THE DRAWINGS

FIG. 1 is a first structural diagram of a multi-pulley telescopic mechanism according to one embodiment of the invention;

FIG. 2 is a second structural diagram of the multi-pulley telescopic mechanism according to one embodiment of the invention;

FIG. 3 is a third structural diagram of the multi-pulley telescopic mechanism according to one embodiment of the invention;

FIG. 4 is a fourth structural diagram of the multi-pulley telescopic mechanism according to one embodiment of the invention;

FIG. 5 is a fifth structural diagram of the multi-pulley telescopic mechanism according to one embodiment of the invention;

FIG. 6 is a sixth structural diagram of the multi-pulley telescopic mechanism according to one embodiment of the invention;

In the FIGS.: 1, basic boom; 2, second boom; 3, third boom; 4, third boom-extension steering mechanism; 5, second boom-extension steering mechanism; 6, fourth boom; 7, fifth boom-extension steering mechanism; 8, fourth boom-extension steering mechanism; 9, sixth boom-extension steering mechanism; 10, fifth boom; 11, third boom-retraction rope; 12, third boom-retraction steering mechanism' 13, first boom-retraction rope; 14, fifth boom-retraction steering mechanism; 15, hinge pin; 16, hinge base; 17, third boom-extension rope; 18, second boom-extension rope; 19, first boom-extension rope; 20, stationary base; 21, first boom-extension steering mechanism; 22, second boom-retraction rope; 23, second boom-retraction steering mechanism; 24, telescopic mechanism; 25, fourth boom-retraction steering mechanism; 26, fourth boom-retraction rope; 27, sixth boom-retraction steering mechanism; 28, fifth boom-retraction steering mechanism; 29, fifth boom-retraction rope.

### DETAILED DESCRIPTION OF THE EMBODIMENTS

The invention is further described below in conjunction with accompanying drawings. The following embodiments are merely used to more clearly explain the technical solutions of the invention and should not be construed as limiting the protection scope of the invention.

In the description of the invention, it should be understood that terms such as “central”, “longitudinal”, “transverse”, “upper”, “lower”, “front”, “back”, “left”, “right”, “vertical”, “horizontal”, “top”, “bottom”, “inner” and “outer” are used to indicate directional or positional relations based on the accompanying drawings merely for facilitating and simplifying the description of the invention, do not indicate or imply that devices or elements referred to must be in a specific direction or be configured and operated in a specific direction, and thus should not be construed as limitations of the invention. In addition, terms such as “first” and “second” are merely used for the purpose of description and should not be construed as indicating or implying relative importance or implicitly indicating the number of technical features referred to. Therefor.

a feature defined by “first” or “second” may explicitly or implicitly indicate the inclusion of one or more said features. In the description of the invention, unless otherwise stated, “multiple” refers to two or more.

In the description of the invention, it should be noted that unless otherwise expressly stated and defined, terms “mount”, “link” and “connect” should be broadly connected. For example. “connect” may refer to fixed connection, detachable connection or integrated connection: or, mechanical connection or electrical connection; or, direct connection, indirect connection by means of an intermediate medium, or internal connection of two elements. Those ordinarily skilled in the art can appreciate the specific meanings of these terms in the invention as the case may be.

The invention provides a multi-pulley telescopic mechanism, comprising a telescopic mechanism 24, a first boom-extension rope 19, a second boom-extension rope 18, a third boom-extension rope 17, a basic boom 1, and a second boom 2, a third boom 3, a fourth boom 6 and a fifth boom 10 which are sequentially inlaid in the basic boom 1. Wherein, the second boom 2 is inlaid in the basic boom 1, the third boom 3 is inlaid in the second boom 2, the fourth boom 6 is inlaid in the third boom 3, the fifth boom 10 is inlaid in the fourth boom 6, and one basic boom 1, one second boom 2, one third boom 3, one fourth boom 6, one fifth boom 10, and one telescopic mechanism 24 are arranged. To better specifically explain the following six embodiments, the multi-pulley telescopic mechanism 24 is divided into an extension part and a retraction part.

### EMBODIMENT 1

### Extension Part:

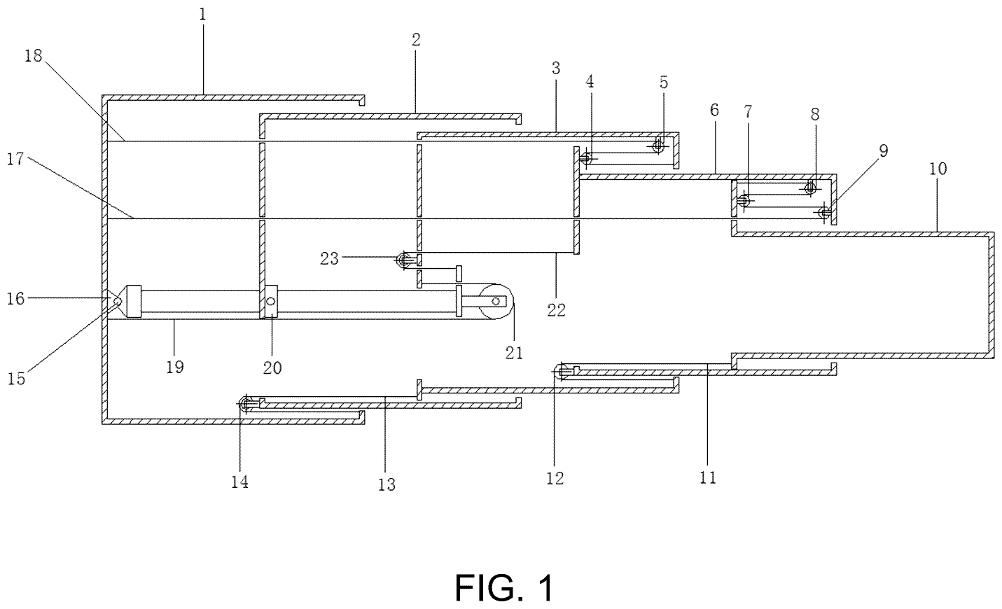

As shown in FIG. 1, a movable tail end of the telescopic mechanism 24 is connected to an inner side of a boom tail of the basic boom 1, In this embodiment, a hinge base 16 is mounted on the inner side of the boom tail of the basic boom 1, and the movable tail end of the telescopic mechanism 24 is hinged to the hinge base 16 by means of a hinge pin 15. A stationary tail end of the telescopic mechanism 24 is connected to an inner side of a boom tail of the second boom 2. In this embodiment, a stationary base 20 is mounted on the inner side of the boom tail of the second boom 2, and the stationary tail end of the telescopic mechanism 24 is hinged to the stationary base 20 by means of a hinge pin 15. A first boom-extension steering mechanism 21 is mounted at a stationary front end of the telescopic mechanism 24, one end of the first boom-extension rope 19 is fixedly connected to an inner side of a boom tail of the third boom 3, the other end of the first boom-extension rope 19 is wound around the first boom-extension steering mechanism 21 and then fixedly connected to the inner side of the boom tail of the basic boom 1, a first boom-extension steering assembly is mounted between a boom head of the third boom 3 and a boom tail of the fourth boom 6, one end of the second boom-extension rope 18 is fixedly connected to the inner side of the boom tail of the basic boom, the other end of the second boom-extension rope 18 is wound around the first boom-extension steering assembly and then fixedly connected to an inner side of the boom head of the third boom 3, a second boom-extension steering assembly is mounted between a boom head of the fourth boom 6 and a boom tail of the fifth boom 10, one end of the third boom-extension rope 17 is fixedly connected to an outer side of the boom tail of the fifth boom 10, and the other end of the third boom-extension rope 17 is wound around the second boom-extension steering assembly and then fixedly connected to the inner side of the boom tail of the basic boom 1. By means of the first boom-extension steering assembly, the second boom-extension rope 18 wound around the first boom-extension steering assembly, the second boom-extension steering assembly and the third boom-extension rope 17 wound around the second boom-extension steering assembly, the force borne by the second boom-extension rope 18 and the force borne by the third boom-extension rope 17 can be effectively reduced, thus effectively improving the hoisting capacity of a crane.

As shown in FIG. 1, the first boom-extension steering assembly comprises a second boom-extension steering mechanism 5 and a third boom-extension steering mechanism 4, wherein the second boom-extension steering mechanism 5 is mounted on the inner side of the boom head of the third boom 3, the third boom-extension steering mechanism 4 is mounted on an outer side of the boom tail of the fourth boom 6, and the other end of the second boom-extension rope 18 is sequentially wound around the second boom-extension steering mechanism 5 and the third boom-extension steering mechanism 4 and then fixedly connected to the inner side of the boom head of the third boom 3.

As shown in FIG. 1, the second boom-extension steering assembly comprises a fourth boom-extension steering mechanism 8, a fifth boom-extension steering mechanism 7 and a sixth boom-extension steering mechanism 9, wherein the fourth boom-extension steering mechanism 8 and the sixth boom-extension steering mechanism 9 are mounted on the inner side of the boom head of the fourth boom 6, the fifth boom-extension steering mechanism 7 is mounted on the outer side of the boom tail of the fifth boom 10, and the other end of the third boom-extension rope 17 is sequentially wound around the fourth boom-extension steering mechanism 8, the fifth boom-extension steering mechanism 7 and the sixth boom-extension steering mechanism 9 and then fixedly connected to the inner side of the boom tail of the basic boom 1. It should be noted that as shown in FIG. 1, the sixth boom-extension steering mechanism is located on an outer side of the third boom-extension rope wound around the fourth boom-extension steering mechanism and the fifth boom-extension steering mechanism.

In application, if a load borne by the fifth boom 10 is T, a load borne by the fourth boom 6 is 4′T/3, a load borne by the third boom-extension rope 17 is T/3, a load borne by the third boom 3 is 2T, and a load borne by the second boom-extension rope 18 is 2T/3. Compared with an existing double-cylinder rope type telescopic mechanism 24, the force borne by the second boom-extension rope 18 and the force borne by the third boom-extension rope 17 are effectively reduced.

### Retraction Part:

As shown in FIG. 1, the multi-pulley telescopic mechanism in this embodiment of the invention further comprises a first boom-retraction rope 13, a second boom-retraction rope 22 and a third boom-retraction rope 11, wherein a first boom-retraction steering mechanism 14 is mounted on an outer side of the boom tail of the second boom 2, one end of the first boom-retraction rope 13 is fixedly connected to an inner side of a boom head of the basic boom 1, the other end of the first boom-retraction rope 13 is wound around the first boom-retraction steering mechanism 14 and then fixedly connected to an outer side of the boom tail of the third boom 3, a second boom-retraction steering mechanism 23 is mounted on the outer side of the boom tail of the third boom 3, one end of the second boom-retraction rope 22 is fixedly connected to the stationary front end of the telescopic mechanism 24, the other end of the second boom-retraction rope 22 is wound around the second boom-retraction steering mechanism 23 and then fixedly connected to the outer side of the boom tail of the fourth boom 6, a third boom-retraction steering mechanism 12 is mounted on the outer side of the boom tail of the fourth boom 6, one end of the third boom-retraction rope 11 is fixedly connected to the inner side of the boom head of the third boom 3, and the other end of the third boom-retraction rope 11 is wound around the third boom-retraction steering mechanism 12 and then fixedly connected to the outer side of the boom tail of the fifth boom 10.

As shown in FIG. 1, in actual application of the extension part and the retraction part, when the telescopic mechanism 24 extends, the second boom 2 is directly driven to extend, the third boom 3 is driven to extend under the action of the first boom-extension steering mechanism 21 and the first boom-extension rope 19, the fourth boom 6 is driven to extend under the action of the second boom-extension steering mechanism 5, the third boom-extension steering mechanism 4 and the second boom-extension rope 18, and the fifth boom 10 is driven to extend under the action of the fourth boom-extension steering mechanism 8, the fifth boom-extension steering mechanism 7, the sixth boom-extension steering mechanism 9 and the third boom-extension rope 17, such that synchronous extension of the second boom, the third boom, the fourth boom and the fifth boom is realized. When the telescopic mechanism 24 retracts, the second boom 2 is directly driven to retract, the third boom 3 is driven to retract under the action of the first boom-retraction steering mechanism 14 and the first boom-retraction rope 13, the fourth boom 6 is driven to retract under the action of the second boom-retraction steering mechanism 23 and the second boom-retraction rope 22, and the fifth boom 10 is driven to retract under the action of the third boom-retraction steering mechanism 12 and the third boom-retraction rope 11, such that synchronous retraction of the second boom, the third boom, the fourth boom and the fifth boom 10 is realized.

The first boom-extension rope 19, the second boom-extension rope 18, the third boom-extension rope 17 and the first boom-traction rope 13 are fixedly connected to the basic boom 1 directly. such that telescoping efficiency of the multi-pulley telescopic mechanism 24 is effectively improved; moreover, synchronous extension and retraction of the first boom, the second boom 2, the third boom 3, the fourth boom 6 and the fifth boom 10 is realized by means of the single telescopic mechanism 24, such that the overall weight and cost of the multi-pulley telescopic mechanism 24 can be effectively reduced, and the hoisting capacity of a carne can be improved to some extent.

### EMBODIMENT 2

### Extension Part:

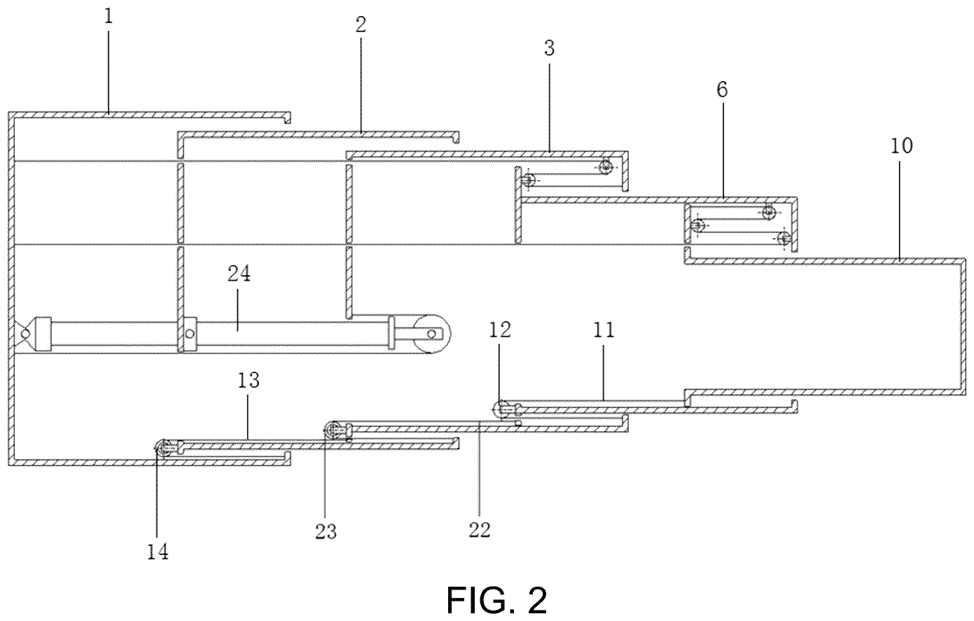

as shown in FIG. 2, the extension part in Embodiment 2 is the same as the extension part in Embodiment 1, and only the retraction part in Embodiment 1 is improved.

### Retraction Part:

as shown in FIG. 2, the multi-pulley telescopic mechanism in this embodiment of the invention further comprises a first boom-retraction rope 13, a second boom-retraction rope 22 and a third boom-retraction rope 11, wherein a first boom-retraction steering mechanism 14 is mounted on an outer side of the boom tail of the second boom 2, one end of the first boom-retraction rope 13 is fixedly connected to an inner side of a boom head of the basic boom 1, the other end of the first boom-retraction rope 13 is wound around the first boom-retraction steering mechanism 14 and then fixedly connected to an outer side of the boom tail of the third boom 3, a second boom-retraction steering mechanism 23 is mounted on the outer side of the boom tail of the third boom 3, one end of the second boom-retraction rope 22 is fixedly connected to an inner side of a boom head of the second boom 2, the other end of the second boom-retraction rope 22 is wound around the second boom-retraction steering mechanism 23 and then fixedly connected to the outer side of the boom tail of the fourth boom 6, a third boom-retraction steering mechanism 12 is mounted on the outer side of the boom tail of the fourth boom 6, one end of the third boom-retraction rope 11 is fixedly connected to the inner side of the boom head of the third boom 3, and the other end of the third boom-retraction rope 11 is wound around the third boom-retraction steering mechanism 12 and then fixedly connected to the outer side of the boom tail of the fifth boom 10.

As shown in FIG. 2, in actual application of the retraction part, when the telescopic mechanism 24 retracts, the second boom 2 is directly driven to retract, the third boom 3 is driven to retract under the action of the first boom-retraction steering mechanism 14 and the first boom-retraction rope 13, the fourth boom 6 is driven to retract under the action of the second boom-retraction steering mechanism 23 and the second boom-retraction rope 22, and the fifth boom 10 is driven to retract under the action of the third boom-retraction steering mechanism 12 and the third boom-retraction rope 11, such that synchronous retraction of the second boom, the third boom, the fourth boom and the fifth boom 10 is realized.

### EMBODIMENT 3

### Extension Part:

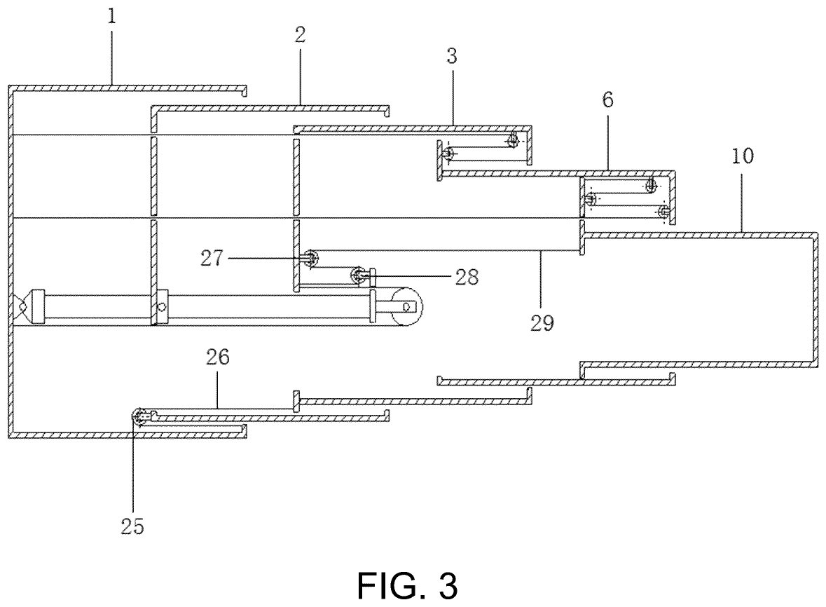

as shown in FIG. 3, the extension part in Embodiment 3 is the same as the extension part in Embodiment 1, and the retraction part in Embodiment 1 is further improved.

### Retraction Part:

As shown in FIG. 3, the multi-pulley telescopic mechanism in this embodiment of the invention further comprises a fourth boom-retraction rope 26 and a fifth boom-retraction rope 29, wherein a fourth boom-retraction steering mechanism 25 is mounted on an outer side of the boom tail of the second boom, one end of the fourth boom-retraction rope 26 is fixedly connected to an inner side of a boom head of the basic boom, the other end of the fourth boom-retraction rope 26 is wound around the fourth boom-retraction steering mechanism 25 and then fixedly connected to the outer side of the boom tail of the third boom, a fifth boom-retraction steering mechanism 28 is mounted at the stationary front end of the telescopic mechanism 24, a sixth boom-retraction steering mechanism 27 is mounted on an inner side of the boom tail of the third boom, one end of the fifth boom-retraction rope 29 is fixedly connected to the inner side of the boom tail of the third boom, and the other end of the fifth boom-retraction rope 29 is sequentially wound around the fifth boom-retraction steering mechanism 28 and the sixth boom-retraction steering mechanism 27 and then fixedly connected to the outer side of the boom tail of the fifth boom.

As shown in FIG. 3, in actual application of the retraction part, when the telescopic mechanism 24 retracts, the second boom 2 is directly driven to retract, the third boom 3 is driven to retract under the action of the fourth boom-retraction steering mechanism 25 and the fourth boom-retraction rope 26, the fifth boom 10 is driven to retract under the action of the fifth boom-retraction steering mechanism 28, the sixth boom-retraction steering mechanism 27 and the fifth boom-retraction rope 29, and the fourth boom 6 is driven to retract under the action of the fourth boom-extension steering mechanism 8, the fifth boom-extension steering mechanism 7, the sixth boom-retraction steering mechanism 9 and the third boom-extension rope 17, such that synchronous retraction of the second boom, the third boom, the fourth boom and the fifth boom 10 is realized.

### EMBODIMENT 4

### Extension Part:

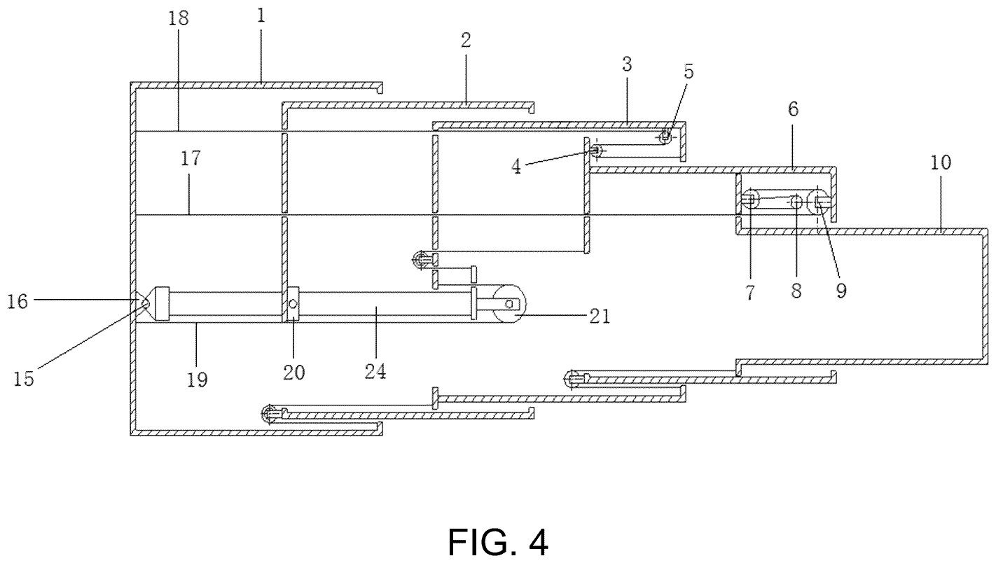

As shown in FIG. 4, a movable tail end of the telescopic mechanism 24 is connected to an inner side of a boom tail of the basic boom 1. In this embodiment, a hinge base 16 is mounted on the inner side of the boom tail of the basic boom 1, and the movable tail end of the telescopic mechanism 24 is hinged to the hinge base 16 by means of a hinge pin 15. A stationary tail end of the telescopic mechanism 24 is connected to an inner side of a boom tail of the second boom 2. In this embodiment, a stationary base 20 is mounted on the inner side of the boom tail of the second boom 2, and the stationary tail end of the telescopic mechanism 24 is hinged to the stationary base 20 by means of the hinge pin 15. A first boom-extension steering mechanism 21 is mounted at a stationary front end of the telescopic mechanism 24, one end of the first boom-extension rope 19 is fixedly connected to an inner side of a boom tail of a third boom 3, the other end of the first boom-extension rope 19 is wound around the first boom-extension steering mechanism 21 and then fixedly connected to the inner side of the boom tail of the basic boom 1, a first boom-extension steering assembly is mounted between a boom head of the third boom 3 and a boom tail of the fourth boom 6, one end of the second boom-extension rope 18 is fixedly connected to the inner side of the boom tail of the basic boom, the other end of the second boom-extension rope 18 is wound around the first boom-extension steering assembly and then fixedly connected to an inner side of the boom head of the third boom 3, a second boom-extension steering assembly is mounted between a boom head of the fourth boom 6 and a boom tail of a fifth boom 10, one end of the first boom-extension rope 17 is fixedly connected to an outer side of the boom tail of the fifth boom 10, and the other end of the third boom-extension rope 17 is wound around the second boom-extension steering assembly and then fixedly connected to the inner side of the boom tail of the basic boom 1. By means of the first boom-extension steering assembly, the second boom-extension rope 18 wound around the first boom-extension steering assembly, the second boom-extension steering assembly and the third boom-extension rope 17 wound around the second boom-extension steering assembly, the force borne by the second boom-extension rope 18 and the force borne by the third boom-extension rope 17 can be effectively reduced, thus effectively improving the hoisting capacity of a crane.

As shown in FIG. 4, the first boom-extension steering assembly comprises a second boom-extension steering mechanism 5 and a third boom-extension steering assembly 4, wherein the second boom-extension steering mechanism 5 is mounted on the inner side of the boom head of the third boom 3, the third boom-extension steering mechanism 4 is mounted on an outer side of the boom tail of the fourth boom 6, and the other end of the second boom-extension rope 18 is sequentially wound around the second boom-extension steering mechanism 5 and the third boom-extension steering mechanism 4 and then fixedly connected to the inner side of the boom head of the third boom 3.

As shown in FIG. 4, the second boom-extension steering assembly comprises a fourth boom-extension steering mechanism 8, a fifth boom-extension steering mechanism 7 and a sixth boom-extension steering mechanism 9, wherein the fourth boom-extension steering mechanism 8 and the sixth boom-extension steering mechanism 9 are mounted on an inner side of the boom head of the fourth boom 6, the fifth boom-extension steering mechanism 7 is mounted on the outer side of the boom tail of the fifth boom 10, and the other end of the third boom-extension rope 17 is sequentially wound around the fourth boom-extension steering mechanism 8, the fifth boom-extension steering mechanism 7 and the sixth boom-extension steering mechanism 9 and then fixedly connected to the inner side of the boom tail of the basic boom 1. It should be noted that as shown in FIG. 4, the sixth boom-extension steering mechanism is located on an inner side of the third boom-extension rope wound around the fourth boom-extension steering mechanism and the fifth boom-extension steering mechanism, and the spatial size of the fourth boom-extension steering mechanism is greater than the spatial size of the sixth boom-extension steering mechanism.

In application, if a load borne by the fifth boom 10 is T, a load borne by the fourth boom 6 is 4T/3, a load borne by the third boom-extension rope 17 is T/3, a load borne by the third boom 3 is 2T, and a load borne by the second boom-extension rope 18 is 2T/3. Compared with an existing double-cylinder rope type telescopic mechanism 24, the force borne by the second boom-extension rope 18 and the force borne by the third boom-extension rope 17 are effectively reduced.

As shown in FIG. 4, in actual application of the extension part, when the telescopic mechanism 24 extends, the second boom 2 is directly driven to extent, the third boom 3 is driven to extend under the action of the first boom-extension steering mechanism 21 and the first boom-extension rope 19, the fourth boom 6 is driven to extend under the action of the second boom-extension steering mechanism 5, the third boom-extension steering mechanism 4 and the second boom-extension rope 18, and the fifth boom 10 is driven to extend under the action of the fourth boom-extension steering mechanism 8, the fifth boom-extension steering mechanism 7, the sixth boom-extension steering mechanism 9 and the third boom-extension rope 17, such that synchronous extension of the second boom, the third boom, the fourth boom and the fifth boom is realized.

### Retraction Part:

As shown in FIG. 4, the retraction part in Embodiment 4 is the same as the retraction part in Embodiment 1, and only the extension part in Embodiment 1 is improved.

### EMBODIMENT 5

### Extension Part:

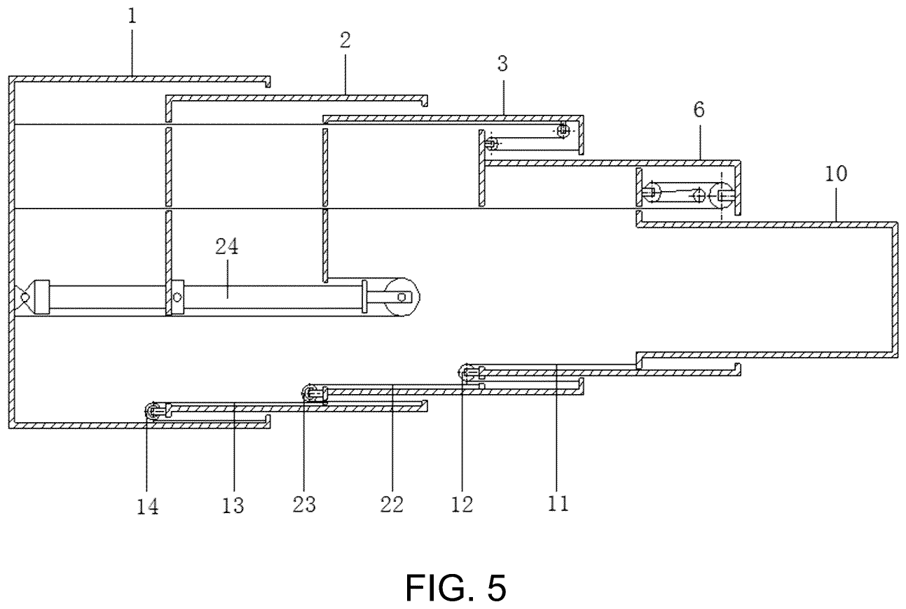

As shown in FIG. 5, the extension part in Embodiment 5 is the same as the extension part in Embodiment 4, and only the retraction part in Embodiment 4 is improved.

### Retraction Part:

As shown in FIG. 5, the multi-pulley telescopic mechanism in this embodiment of the invention further comprises a first boom-retraction rope 13, a second boom-retraction rope 22 and a third boom-retraction rope 11, wherein a first boom-retraction steering mechanism 14 is mounted on an outer side of the boom tail of the second boom 2, one end of the first boom-retraction rope 13 is fixedly connected to the inner side of the boom head of the basic boom 1, the other end of the first boom-retraction rope 13 is wound around the first boom-retraction steering mechanism 14 and then fixedly connected to an outer side of the boom tail of the third boom 3, a second boom-retraction steering mechanism 23 is mounted on the outer side of the boom tail of the third boom 3, one end of the second boom-retraction rope 22 is fixedly connected to an inner side of the boom head of the second boom 2, the other end of the second boom-retraction rope 22 is wound around the second boom-retraction steering mechanism 23 and then fixedly connected to the outer side of the boom tail of the fourth boom 6, a third boom-retraction steering mechanism 12 is mounted on the outer side of the boom tail of the fourth boom 6, one end of the third boom-retraction rope 11 is fixedly connected to the inner side of the boom head of the third boom 3, and the other end of the third boom-retraction rope 11 is wound around the third boom-retraction steering mechanism 12 and then fixedly connected to the outer side of the boom tail of the fifth boom 10.

As shown in FIG. 5, in actual application of the retraction part, when the telescopic mechanism 24 retracts, the second boom 2 is directly driven to retract, the third boom 3 is driven to retract under the action of the first boom-retraction steering mechanism 14 and the first boom-retraction rope 13, the fourth boom 6 is driven to retract under the action of the second boom-retraction steering mechanism 23 and the second boom-retraction rope 22, and the fifth boom 10 is driven to retract under the action of the third boom-retraction steering mechanism 12 and the third boom-retraction rope 11, such that synchronous retraction of the second boom, the third boom, the fourth boom and the fifth boom 10 is realized.

### EMBODIMENT 6

### Extension Part:

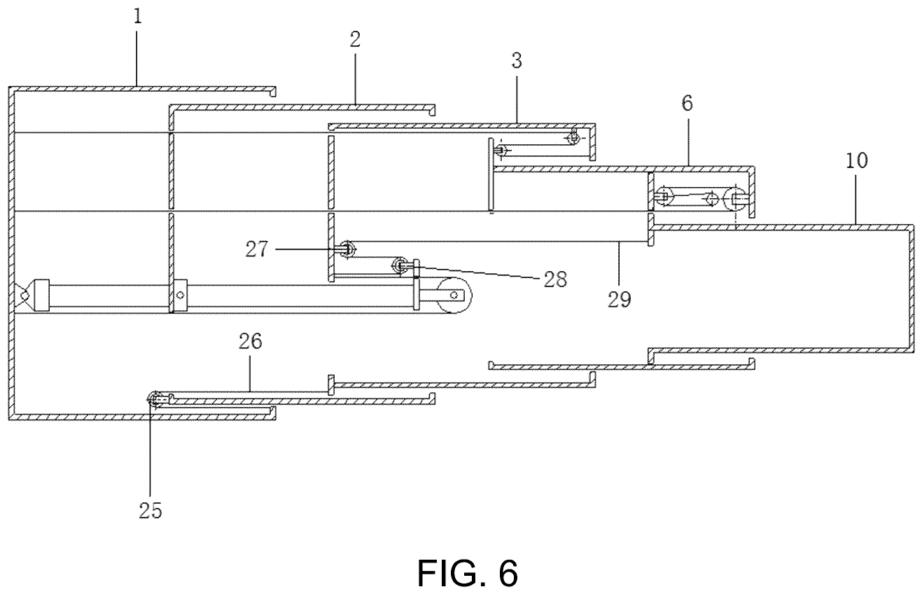

as shown in FIG. 6, the extension part in Embodiment 6 is the same as the extension part in Embodiment 4, and the retraction part in Embodiment 4 is further improved.

### Retraction Part:

As shown in FIG. 6, the multi-pulley telescopic mechanism in this embodiment of the invention further comprises a fourth boom-retraction rope 26 and a fifth boom-retraction rope 29, wherein a fourth boom-retraction steering mechanism 25 is mounted on an outer side of the boom tail of the second boom, one end of the fourth boom-retraction rope 26 is fixedly connected to an inner side of a boom head of the basic boom, the other end of the fourth boom-retraction rope 26 is wound around the fourth boom-retraction steering mechanism 25 and then fixedly connected to an outer side of the boom tail of the third boom, a fifth boom-retraction steering mechanism 28 is mounted at the stationary front end of the telescopic mechanism 24, a sixth boom-retraction steering mechanism 27 is mounted on an inner side of the boom tail of the third boom, one end of the fifth boom-retraction rope 29 is fixedly connected to the inner side of the boom tail of the third boom, and the other end of the fifth boom-retraction rope 29 is sequentially wound around the fifth boom-retraction steering mechanism 28 and the sixth boom-retraction steering mechanism 27 and then fixedly connected to the outer side of the boom tail of the fifth boom.

As shown in FIG. 6, in actual application of the retraction part, when the telescopic mechanism 24 retracts, the second boom 2 is directly driven to retract, the third boom 3 is driven to retract under the action of the fourth boom-retraction steering mechanism 25 and the fourth boom-retraction rope 26, the fifth boom 10 is driven to retract under the action of the fifth boom-retraction steering mechanism 28, the sixth boom-retraction steering mechanism 27 and the fifth boom-retraction rope 29, and the fourth boom 6 is driven to retract under the action of the fourth boom-extension steering mechanism 8, the fifth boom-extension steering mechanism 7, the sixth boom-extension steering mechanism 9 and the third boom-extension rope 17, such that synchronous retraction of the second boom, the third boom, the fourth boom and the fifth boom 10 is realized.

In the embodiments 1-6, the first boom-extension rope, the second boom-extension rope, the third boom-extension rope, the first boom-retraction rope, the second boom-retraction rope, the third boom-retraction rope, the fourth boom-retraction rope 26 and the fifth boom-retraction rope 29 may be stay ropes.

In the embodiments 1-6, the first boom-extension steering mechanism, the second boom-extension steering mechanism, the third boom-extension steering mechanism, the fourth boom-extension steering mechanism, the fifth boom-extension steering mechanism, the sixth boom-extension steering mechanism, the first boom-retraction steering mechanism, the second boom-retraction steering mechanism, the third boom-retraction steering mechanism, the fourth boom-retraction steering mechanism 25, the fifth boom-retraction steering mechanism 28 and the sixth boom-retraction steering mechanism 27 may be pulleys, such that friction can be effectively reduced.

It should be noted that in the embodiments 1-6, the telescopic mechanism 24 is a telescopic cylinder, wherein a tail end of a piston of the telescopic cylinder is the movable tail end of the telescopic mechanism 24, a tail end of a cylinder barrel of the telescopic cylinder is the stationary tail end of the telescopic mechanism 24, and a front end of the cylinder barrel of the telescopic cylinder is the stationary front end of the telescopic mechanism 24.

### EMBODIMENT 7

This embodiment of the invention provides a crane, comprising the multi-pulley telescopic mechanism 24 described above. Because the technical improvements and effects of the crane are the same as the technical improvements and effects of the telescopic mechanism 24 described above, the crane will not be detailed anymore.

The above embodiments are merely preferred ones of the invention. It should be noted that those ordinarily skilled in the art can make some improvements and transformations without departing from the technical principle of the invention, and all these improvements and transformations should also fall within the protection scope of the invention.

1. A multi-pulley telescopic mechanism, comprising a telescopic mechanism, a first boom-extension rope, a second boom-extension rope, a third boom-extension rope, a basic boom, and a second boom, a third boom, a fourth boom and a fifth boom which are sequentially inlaid in the basic boom;
a movable tail end of the telescopic mechanism is connected to the basic boom, a stationary tail end of the telescopic mechanism is connected to the second boom, a first boom-extension steering mechanism is mounted at a stationary front end of the telescopic mechanism, one end of the first boom-extension rope is fixedly connected to the third boom, an other end of the first boom-extension rope is wound around the first boom-extension steering mechanism and then fixedly connected to the basic boom, a first boom-extension steering assembly is mounted between the third boom and the fourth boom, one end of the second boom-extension rope is fixedly connected to the basic boom, an other end of the second boom-extension rope is wound around the first boom-extension steering assembly and then fixedly connected to the third boom, a second boom-extension steering assembly is mounted between the fourth boom and the fifth boom, one end of the third boom-extension rope is fixedly connected to the fifth boom, and an other end of the third boom-extension rope is wound around the second boom-extension steering assembly and then fixedly connected to the basic boom.

2. The multi-pulley telescopic mechanism according to claim 1, wherein the movable tail end of the telescopic mechanism is connected to a boom tail of the basic boom, the stationary tail end of the telescopic mechanism is connected to a boom tail of the second boom, the one end of the first boom-extension rope is fixedly connected to a boom tail of the third boom, the other end of the first boom-extension rope is wound around the first boom-extension steering mechanism and then fixedly connected to the boom tail of the basic boom, the first boom-extension steering assembly is mounted between a boom head of the third boom and a boom tail of the fourth boom, the one end of the second boom-extension rope is fixedly connected to the boom tail of the basic boom, the other end of the second boom-extension rope is wound around the first boom-extension steering assembly and then fixedly connected to the boom head of the third boom, the second boom-extension steering assembly is mounted between a boom head of the fourth boom and a boom tail of the fifth boom, the one end of the third boom-extension rope is fixedly connected to the boom tail of the fifth boom, and the other end of the third boom-extension rope is wound around the second boom-extension steering assembly and then fixedly connected to the boom tail of the basic boom.

3. The multi-pulley telescopic mechanism according to claim 2, wherein the first boom-extension steering assembly comprises a second boom-extension steering mechanism and a third boom-extension steering mechanism, the second boom-extension steering mechanism is mounted on the third boom, the third boom-extension steering mechanism is mounted on the fourth boom, and the other end of the second boom-extension rope is sequentially wound around the second boom-extension steering mechanism and the third boom-extension steering mechanism and then fixedly connected to the third boom.

4. The multi-pulley telescopic mechanism according to claim 3, wherein the second boom-extension steering mechanism is mounted at the boom head of the third boom, the third boom-extension steering mechanism is mounted at the boom tail of the fourth boom, and the other end of the second boom-extension rope is sequentially wound around the second boom-extension steering mechanism and the third boom-extension steering mechanism and then fixedly connected to the boom head of the third boom.

5. The multi-pulley telescopic mechanism according to claim 4, wherein the second boom-extension steering assembly comprises a fourth boom-extension steering mechanism, a fifth boom-extension steering mechanism and a sixth boom-extension steering mechanism, the fourth boom-extension steering mechanism and the sixth boom-extension steering mechanism are mounted on the fourth boom, the fifth boom-extension steering mechanism is mounted on the fifth boom, and the other end of the third boom-extension rope is sequentially wound around the fourth boom-extension steering mechanism, the fifth boom-extension steering mechanism and the sixth boom-extension steering mechanism and then fixedly connected to the basic boom.

6. The multi-pulley telescopic mechanism according to claim 5, wherein the fourth boom-extension steering mechanism and the sixth boom-extension steering mechanism are mounted at the boom head of the fourth boom, the fifth boom-extension steering mechanism is mounted at the boom tail of the fifth boom, and the other end of the third boom-extension rope is sequentially wound around the fourth boom-extension steering mechanism, the fifth boom-extension steering mechanism and the sixth boom-extension steering mechanism and then fixedly connected to the boom tail of the basic boom.

7. The multi-pulley telescopic mechanism according to claim 6, wherein the sixth boom-extension steering mechanism is located on an outer side of the third boom-extension rope wound around the fourth boom-extension steering mechanism and the fifth boom-extension steering mechanism.

8. The multi-pulley telescopic mechanism according to claim 6, wherein the sixth boom-extension steering mechanism is located on an inner side of the third boom-extension rope wound around the fourth boom-extension steering mechanism and the fifth boom-extension steering mechanism.

9. The multi-pulley telescopic mechanism according to claim 8, wherein a spatial size of the fourth boom-extension steering mechanism is greater than a spatial size of the sixth boom-extension steering mechanism.

10. The multi-pulley telescopic mechanism according to claim 6, further comprising a first boom-retraction rope, a second boom-retraction rope and a third boom-retraction rope, wherein a first boom-retraction steering mechanism is mounted at the boom tail of the second boom, one end of the first boom-retraction rope is fixedly connected to a boom head of the basic boom, an other end of the first boom-retraction rope is wound around the first boom-retraction steering mechanism and then fixedly connected to the boom tail of the third boom, a second boom-retraction steering mechanism is mounted at the boom tail of the third boom, one end of the second boom-retraction rope is fixedly connected to the stationary front end of the telescopic mechanism or a boom head of the second boom, an other end of the second boom-retraction rope is wound around the second boom-retraction steering mechanism and then fixedly connected to the boom tail of the fourth boom, a third boom-retraction steering mechanism is mounted at the boom tail of the fourth boom, one end of the third boom-retraction rope is fixedly connected to the boom head of the third boom, and an other end of the third boom-retraction rope is wound around the third boom-retraction steering mechanism and then fixedly connected to the boom tail of the fifth boom.

11. The multi-pulley telescopic mechanism according to claim 6, further comprising a fourth boom-retraction rope and a fifth boom-retraction rope, wherein a fourth boom-retraction steering mechanism is mounted at the boom tail of the second boom, one end of the fourth boom-retraction rope is fixedly connected to a boom head of the basic boom, an other end of the fourth boom-retraction rope is wound around the fourth boom-retraction steering mechanism and then fixedly connected to the boom tail of the third boom, a fifth boom-retraction steering mechanism is mounted at the stationary front end of the telescopic mechanism, a sixth boom-retraction steering mechanism is mounted at the boom tail of the third boom, one end of the fifth boom-retraction rope is fixedly connected to the boom tail of the third boom, and an other end of the fifth boom-retraction rope is sequentially wound around the fifth boom-retraction steering mechanism and the sixth boom-retraction steering mechanism and then fixedly connected to the boom tail of the fifth boom.

12. The multi-pulley telescopic mechanism according to claim 6, wherein the first boom-extension steering mechanism, the second boom-extension steering mechanism, the third boom-extension steering mechanism, the fourth boom-extension steering mechanism, the fifth boom-extension steering mechanism and the sixth boom-extension steering mechanism are all pulleys.

13. The multi-pulley telescopic mechanism according to claim 10, wherein the first boom-retraction steering mechanism, the second boom-retraction steering mechanism and the third boom-retraction steering mechanism are all pulleys.

14. The multi-pulley telescopic mechanism according to claim 11, wherein the fourth boom-retraction steering mechanism, the fifth boom-retraction steering mechanism and the sixth boom-retraction steering mechanism are all pulleys.

15. The multi-pulley telescopic mechanism according to claim 1, wherein a hinge base is mounted at a boom tail of the basic boom, the movable tail end of the telescopic mechanism is hinged to the hinge base by means of a hinge pin, a stationary base is mounted at a boom tail of the second boom, and the stationary tail end of the telescopic mechanism is hinged to the stationary base by means of a hinge pin.

16. The multi-pulley telescopic mechanism according to claim 1, wherein the telescopic mechanism is a telescopic cylinder, a tail end of a piston of the telescopic cylinder is the movable tail end of the telescopic mechanism, a tail end of a cylinder barrel of the telescopic cylinder is the stationary tail end of the telescopic mechanism, and a front end of the cylinder barrel of the telescopic cylinder is the stationary front end of the telescopic mechanism.

17. A crane, characterized by, comprising the multi-pulley telescopic mechanism according to claim 1.
